(19) United States
(12) Patent Application Publication
(10) Pub. No.: US 2015/0161749 A1
(43) Pub. Date: Jun. 11, 2015

(54) NETWORK SYSTEM BASED ON DIGITAL RESOURCES AND APPLICATION METHOD THEREOF

(71) Applicant: Jinxu Huang, Xiamen (CN)

(72) Inventor: Jinxu Huang, Xiamen (CN)

(73) Assignee: Xiamen Geeboo Information Technology Co. Ltd., Xiamen (CN)

(21) Appl. No.: 14/411,687

(22) PCT Filed: Jul. 3, 2012
(86) PCT No.: PCT/CN2012/078130

§ 371 Date: Dec. 29, 2014

(51) Int. Cl. G06Q 50/18; G06Q 10/00

(52) U.S. Cl. CPC G06Q 50/184; G06Q 10/00

(57) ABSTRACT

The present disclosure discloses a network system based on digital resources and an application method thereof, and the network system comprises: a storage module, used for storing digital resources; a search module, used for searching in said storage module, according to a search instruction of a first user, digital resources other users have shared; an establishment module, used for establishing, according to an association establishing instruction of the first user, associations between said first user and other users who have purchased, borrowed, and/or collected said digital resources for which said first user has searched; and a borrowing module, used for borrowing, by said first user, use rights of the digital resources from other users with whom said associations have been established. Social networks in which associations among users can be established based on digital resources are realized by the present disclosure.

### FIELD OF THE INVENTION

The present disclosure relates to the field of internet social network, and particularly to a network system based on digital resources and an application method thereof.

### BACKGROUND OF THE INVENTION

With the development of social networking, the image of an individual user on the network is becoming more and more complete. The users can be connected through network carrier, whereby a group with a certain characteristic, i.e., a social network is formed. With the emerging of mobile internet in recent years, social networks connect people even closer by virtue of the universality of mobile terminals and the application of wireless networks.

However, friend-making application is just a beginning of social networks, and the whole development process of Social Network Services (SNS) follows the pattern that people gradually transfer more complete information stream in off-line life to on-line for low cost management, which is not only a popular business model, but also a key strength pushing internet infinitely close to the real world.

There are serious problems of assimilation phenomena in current social networks, and most of them can provide “additional entertainment” only. Till now, there is not a social network based on digital resources, such as e-books, digital music, documents, movies and other basic elements of “normal life”.

### SUMMARY OF THE INVENTION

The technical problem to be solved by the present disclosure is to provide social networks based on digital resources.

To solve the above technical problem, the present disclosure provides a network system based on digital resources, comprising:

a storage module, used for storing digital resources;

a search module, used for searching in said storage module, according to a search instruction of a first user, digital resources other users have shared;

an establishment module, used for establishing, according to an association establishing instruction of the first user, associations between said first user and other users who have purchased, borrowed, and/or collected said digital resources for which said first user has searched; and

a borrowing module, used for borrowing, by said first user, use rights of the digital resources from other users with whom said associations have been established.

Preferably, the network system comprises:

a sharing module, used for sharing, according to a sharing instruction of said first user, digital resources of said first user to other users.

Preferably, the network system comprises:

a browse module, used for browsing, by said first user, digital resources of other users with whom said associations have been established.

Preferably, the network system comprises:

a return module, used for returning digital resources borrowed by said first user from other users with whom said associations have been established, when a preset borrowing deadline of digital resources borrowed by said first user from other users with whom said associations have been established expires, or a return request sent by said first user is received.

Preferably, the network system comprises:

an interaction module, used for interacting, according to an interaction instruction of said first user, between said first user and other users who have purchased, borrowed, and/or collected digital resources for which said first user has searched.

Preferably, the network system comprises:

an upload module, used for uploading digital resources of said first user according to an upload operation of said first user.

Preferably, the network system comprises:

a categorization module, used for categorizing digital resources of said first user according to a categorization operation of said first user.

Preferably, the network system comprises:

a grouping module, used for grouping other users with whom said associations have been established.

The present disclosure further provides a method for using the network system based on digital resources, comprising the steps of:

storing digital resources in said storage module;

searching, by said search module, according to a search instruction of a first user, digital resources other users have shared in digital resources stored in said storage module;

establishing, by said establishment module, according to an association establishing instruction of the first user, associations between said first user and other users who have purchased, borrowed, and/or collected said digital resources for which the first user has searched; and

borrowing, by said first user, use rights of the digital resources from other users with whom said associations have been established via said borrowing module.

Preferably, the method comprises:

sharing, according to a sharing instruction of said first user, digital resources of said first user to other users.

Preferably, the method comprises:

returning digital resources borrowed from other users with whom said associations have been established, when a preset borrowing deadline of digital resources borrowed by said first user from other users with whom said associations have been established expires, or a return request sent by said first user is received.

Preferably, the method comprises:

interacting, according to an interaction instruction of said first user, between said first user and other users who have purchased, borrowed, and/or collected digital resources for which the first user has searched.

Preferably, the method comprises:

uploading digital resources of said first user according to an upload operation of said first user.

Compared with the prior art, a social network in which associations among users can be established based on digital resources is realized by the embodiment of the present disclosure. The interaction and circulation of digital resources among users can be realized by the embodiment of the present disclosure.

Other features and advantages of the present disclosure will be further explained in the following description, and partially become self-evident therefrom, or be understood through the embodiment of the present disclosure.

### BRIEF DESCRIPTION OF THE DRAWINGS

FIG. 1 schematically shows the structure of a network system based on digital resources according to an embodiment of the present disclosure; and

FIG. 2 is a flow chart of a method for using the network system based on digital resources according to an embodiment of the present disclosure.

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It is important to note that as long as there is no structural conflict, all the technical features mentioned in all the embodiments may be combined together in any manner, and the technical solutions obtained in this manner all fall within the scope of the present disclosure.

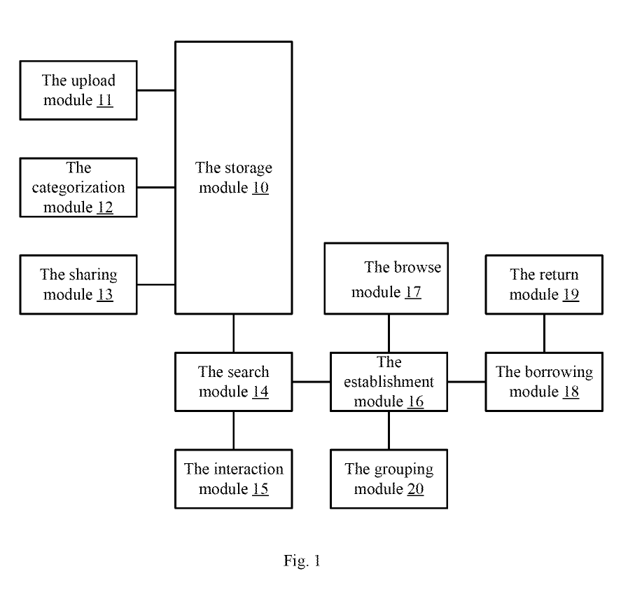

As shown in FIG. 1, a network system based on digital resources according to an embodiment of the present disclosure mainly comprises a storage module 10, a search module 14, and an establishment module 16.

The storage module 10 is used for storing digital resources.

The search module 14 is connected with the storage module 10, and is used for searching in the storage module 10, according to a search instruction of a first user, digital resources other users have shared.

The establishment module 16 is connected with the search module 14, and is used for establishing, according to an association establishing instruction of the first user, associations between said first user and other users who have purchased, borrowed, and/or collected said digital resources for which said first user has searched.

As shown in FIG. 1, the network system based on digital resources according to the embodiment of the present disclosure may further comprise at least one module selected from a group consisting of an upload module 11, a categorization module 12, a sharing module 13, an interaction module 15, a browse module 17, a borrowing module 18, a return module 19 and a grouping module 20.

The upload module 11 is used for uploading digital resources of said first user, according to an upload operation of said first user, to the storage module 10 for storage.

The categorization module 12 is connected with the storage module 10, and is used for categorizing digital resources of the first user according to a categorization operation of the first user.

The sharing module 13 is connected with the storage module 10, and is used for sharing, according to a sharing instruction of the first user, digital resources of the first user to other users.

The interaction module 15 is connected with the search module 14, and is used for interacting, according to an interaction instruction of said first user, between said first user and other users who have purchased, borrowed, and/or collected digital resources for which said first user has searched.

The browse module 17 is connected with the establishment module 16, and is used for browsing, by said first user, digital resources of other users with whom said associations have been established.

The borrowing module 18 is connected with the establishment module 16, and is used for borrowing, by said first user, use rights of the digital resources from other users with whom said associations have been established. With respect to a certain digital resource, it can only be used by one user at any moment. After the first user has borrowed the use right of the digital resource from other user with whom an association has been established, the user who has lent the use right of the digital resource to the first user cannot use the digital resource until the first user returns the use right of the digital resource.

According to the embodiment of the present disclosure, user A and user B, after becoming members of the network system based on digital resources through registration, can upload their respective digital resources to the network system, share their respective digital resources through the sharing module 13, and categorize their respective digital resources through the categorization module 12.

User A searches digital resources shared by other users (include user B) through the search module 14 at his/her will, interacts with other users who have purchased, borrowed, and/or collected digital resources for which the first user has searched through the interaction module 15, and establishes associations with other users who have purchased, borrowed, and/or collected said digital resources, such as user B, through the establishment module 16. User A can interactively communicate with user B as well as other users through short messages.

After the association between user A and user B is established, user A can browse the digital resource of user B through the browse module 17, and then borrow the digital resource of user B which is only accessible to user A with whom an association has been established. After the digital resource of user B is lent to user A, user B cannot perform any operation on the digital resource lent to user A.

According to the embodiment of the present disclosure, the network system further comprises a return module 19, which is connected with the borrowing module 18 and is used for returning digital resources borrowed by the first user (for example, user A) from other users (for example, user B) with whom an association has been established, when a preset borrowing deadline of digital resources borrowed by user A from user B expires, or a return request sent by user A is received. With respect to the digital resource lent to user A, before or upon the expiration of the borrowing deadline of the digital resource, user A may request user B for renewal. The digital resource lent to user A can be renewed to user A after approval of user B.

According to the embodiment of the present disclosure, the network system further comprises a grouping module 20, which is connected with the establishment module 16 and is used for grouping, after associations between the first user and other users have been established, other users with whom said associations have been established.

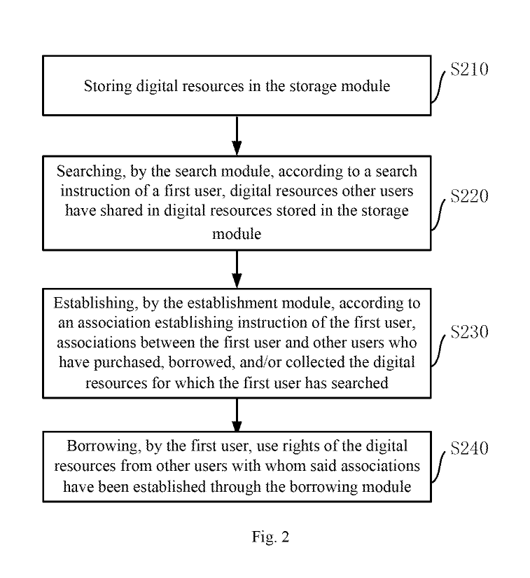

As shown in FIG. 2, the method for using the network system based on digital resources according to the embodiment of the present disclosure mainly comprises the following steps.

In step S210, digital resources are stored in the storage module.

In step S220, the search module searches digital resources other users have shared in digital resources stored in the storage module, according to a search instruction of a first user.

In step S230, the establishment module establishes associations between said first user and other users who have purchased, borrowed, and/or collected said digital resources for which the first user has searched, according to an association establishing instruction of the first user.

In step S240, the first user borrows use rights of the digital resources from other users with whom said associations have been established through said borrowing module.

The method of the embodiment of the present disclosure may further comprise the following step: the digital resources of the first user are shared to other users according to a sharing instruction of the first user.

The method of the embodiment of the present disclosure may further comprise the following step: when a preset borrowing deadline of digital resources borrowed by the first user from other users with whom said associations have been established expires, or a return request sent by the first user is received, the digital resources borrowed from other users with whom said associations have been established are returned.

The method of the embodiment of the present disclosure may further comprise the following step: the first user interacts with other users who have purchased, borrowed, and/or collected digital resources for which the first user has searched according to an interaction instruction of the first user.

The method of the embodiment of the present disclosure may further comprise the following step: the digital resources of the first user are uploaded to the storage module according to an upload operation of the first user.

The above embodiments are described only for better understanding, rather than restricting, the present disclosure. Any person skilled in the art can make amendments to the implementing forms or details without departing from the spirit and scope of the present disclosure. The protection scope of the present disclosure shall be determined by the scope as defined in the claims.

1. A network system based on digital resources, comprising:
a storage module, used for storing digital resources;
a search module, used for searching in said storage module, according to a search instruction of a first user, digital resources other users have shared;
an establishment module, used for establishing, according to an association establishing instruction of the first user, associations between said first user and other users who have purchased, borrowed, and/or collected said digital resources for which said first user has searched; and
a borrowing module, used for borrowing, by said first user, use rights of the digital resources from other users with whom said associations have been established.

2. The network system according to claim 1, further comprising:
a sharing module, used for sharing, according to a sharing instruction of said first user, digital resources of said first user to other users.

3. The network system according to claim 1, further comprising:
a browse module, used for browsing, by said first user, digital resources of other users with whom said associations have been established.

4. The network system according to claim 1, further comprising:
a return module, used for returning digital resources borrowed by said first user from other users with whom said associations have been established, when a preset borrowing deadline of digital resources borrowed by said first user from other users with whom said associations have been established expires, or a return request sent by said first user is received.

5. The network system according to claim 1, further comprising:
an interaction module, used for interacting, according to an interaction instruction of said first user, between said first user and other users who have purchased, borrowed, and/or collected digital resources for which said first user has searched.

6. The network system according to claim 1, further comprising:
an upload module, used for uploading digital resources of said first user according to an upload operation of said first user.

7. The network system according to claim 1, further comprising:
a categorization module, used for categorizing digital resources of said first user according to a categorization operation of said first user.

8. The network system according to claim 1, further comprising:
a grouping module, used for grouping other users with whom said associations have been established.

9. A method for using the network system based on digital resources according to claim 1, comprising the steps of:
storing digital resources in said storage module;
searching, by said search module, according to a search instruction of a first user, digital resources other users have shared in digital resources stored in said storage module;
establishing, by said establishment module, according to an association establishing instruction of the first user, associations between said first user and other users who have purchased, borrowed, and/or collected said digital resources for which the first user has searched; and
borrowing, by said first user, use rights of the digital resources from other users with whom said associations have been established through said borrowing module.

10. The method according to claim 9, further comprising:
sharing, according to a sharing instruction of said first user, digital resources of said first user to other users.

11. The method according to claim 9, further comprising:
returning digital resources borrowed from other users with whom said associations have been established, when a preset borrowing deadline of digital resources borrowed by said first user from other users with whom said associations have been established expires, or a return request sent by said first user is received.

12. The method according to claim 9, further comprising:
interacting, according to an interaction instruction of said first user, between said first user and other users who have purchased, borrowed, and/or collected digital resources for which the first user has searched.

13. The method according to claim 9, further comprising:
uploading digital resources of said first user according to an upload operation of said first user.
